(19) United States
(12) Patent Application Publication
(10) Pub. No.: US 2007/0086924 A1
(43) Pub. Date: Apr. 19, 2007

(54) Pipette with contamination indicator

(75) Inventor: Albert J. Moses, West Chester, PA (US)

Correspondence Address: JOSEPH M. KONIECZNY, P.C., PO Box 387, CONSHOHOCKEN, PA, 19428-0387, US

(73) Assignee: Drummond Scientific Company, Broomall, PA (US)

(21) Appl. No.: 11/252,833

(22) Filed: Oct. 18, 2005

(51) Int. Cl. B01L 3/02

(52) U.S. Cl. 422/100

(57) ABSTRACT

A disposable, contamination-indicating pipette for metering liquids containing a specified agent. The pipette has a main body portion having a volume V and a diameter D, an open-ended upper connection portion, and an open-ended lower tip portion. An indicator in the connection portion provides an observable indication that liquid has entered the connection portion.

### FIELD OF THE INVENTION

The invention relates to a pipette having an apparatus that indicates whether the user has admitted an amount of liquid greater than the capacity of the pipette, thereby causing liquid to enter and to contaminate the nosepiece of the pipette dispenser to which the pipette is connected.

### BACKGROUND OF THE INVENTION

It is known in the prior art to provide a white cotton insert in the upper end of a laboratory pipette. The original function of the insert is unknown. In fact, the cotton insert has more functional disadvantages than advantages. Nevertheless, manufacturers continue to make pipettes with said cotton insert.

During pipetting, an operator may unknowingly admit an amount of liquid greater than the capacity of the pipette, thereby causing liquid to enter and to contaminate the nosepiece of the pipette dispenser to which the pipette is connected. The aforementioned traditional cotton insert provides little or no resistance to liquid flow into the nosepiece of the pipette dispenser. Often, and more importantly, the operator may not realize that he has overfilled the pipette and contaminated the pipette dispenser, since the white cotton insert may have no noticeable change in appearance if contacted by a liquid. Therefore, it would be desirable to provide a pipette that indicates whether the pipette has been overfilled, thereby giving an indication that the nosepiece of the pipette dispenser may have been contaminated.

It is known in the prior art to provide a filter in the internal channel of a pipette dispenser. For example, Torti, U.S. Pat. No. 6,123,905, teaches a pipetter having a filter plug located within an interior channel. The filter plug may be treated with a chemical to affect a color change upon contact with liquid. However, because the filter is located internally within the pipetter, it is not visible to the operator without disassembling the pipetter. Therefore, it would be desirable to provide a pipette that includes a contamination indicator that is visible to the operator without disassembling the pipetter.

### SUMMARY OF THE INVENTION

The invention provides a disposable pipette having an indicator that visually identifies whether the user has admitted an amount of liquid greater than the capacity of the pipette, thereby causing liquid to enter and to contaminate the nosepiece of the pipette dispenser. The disposable pipette has a main body portion with a volume V and a diameter D, an open-ended upper connection portion, and an open-ended lower tip portion. An indicator in the connection portion provides an observable indication that an amount of liquid greater than V has been admitted to the pipette and that liquid may have flown out the open upper end into the nosepiece of the pipette dispenser. Preferably, liquid can not flow out the open end of the connection portion without contacting the indicator. Preferably, the observable indication is irreversible.

In a preferred embodiment, the indicator comprises an insert of porous material that changes color after contacting the liquid. For example, the insert may comprise a cotton swab that has been chemically treated with cobalt chloride, which initially turns the cotton swab blue prior to contact with liquid. After the cotton swab contacts an aqueous solution, the cotton swab turns red, thereby indicating to the operator that he has overfilled the pipette and may have contaminated the nosepiece of the pipette dispenser.

In another embodiment, the indicator reacts with a predetermined agent within the base liquid. The indicator provides an observable indication that the predetermined agent within the liquid has entered the connection portion. The reaction between the indicator and the agent may provide a much more noticeable indication than the reaction between the indicator and the base liquid.

If the indicator is designed to react with any aqueous solution, the pipette may include means for preventing the indicator from absorbing ambient moisture. In a preferred embodiment, the preventing means comprises a deliquescing agent that prevents the insert from absorbing moisture unless the humidity level is greater than about 95%.

In another embodiment, the indicator comprises a coating on the inner surface of the upper connection portion that changes its appearance after contacting liquid. The coating may comprise cobalt chloride.

In a further embodiment, the pipette includes means for preventing liquid from flowing out the open end of the connection portion. Preferably, the preventing means comprises a material that is initially porous to air but becomes impervious to air and liquid upon contact with liquid. For example, the porous material may comprise sintered polyethylene treated with a hydrophilic material such as, for example, starch.

In yet another embodiment, the disposable contamination-indicating pipette includes an indicator in the connection portion that provides an observable indication that a predetermined amount of a particular aerosol created by said liquid has entered the connection portion. The indicator is designed to change color after a predetermined duration of exposure to an aerosol generated from the liquid in the pipette.

In accordance with the method of another embodiment of the invention, a plurality of disposable, contamination-indicating pipettes for metering liquids containing a specified agent are provided. A first pipette is connected to a pipette dispenser, which is used to meter liquid. Each time liquid is admitted to the pipette, the indicator is observed by the operator. The pipette is replaced if an observable characteristic of the indicator changes.

In accordance with the method of a further embodiment of the invention, the pipettes are used to meter liquid and record the contamination history of the dispenser. Initially, a plurality of disposable, contamination-indicating pipettes are provided. A first pipette is connected to the pipette dispenser. Each pipette is used to meter a predetermined quantity of liquid with the pipette and then is replaced. The used pipettes are stored in an ordered series to provide a contamination history of the dispenser.

### BRIEF DESCRIPTION OF THE DRAWINGS

FIG. 1 is a fragmented, side-elevational view of a disposable, contamination-indicating pipette in accordance with an embodiment of the invention;

FIG. 2 is a side elevational view of a contamination-indicating pipette in accordance with another embodiment of the invention connected to a pipette dispenser;

FIG. 3 is an enlarged, fragmented, side elevational view of a disposable, contamination-indicating pipette in accordance with an additional embodiment of the invention; and,

FIG. 4 is an enlarged, fragmented, side elevational view of a disposable contamination-indicating pipette in accordance with a further embodiment of the invention.

### DETAILED DESCRIPTION OF PREFERRED EMBODIMENTS

For the purpose of illustration, there is shown in the accompanying drawings several embodiments of the invention. However, it should be understood by those of ordinary skill in the art that the apparatus and method are not limited to the precise arrangements and instrumentalities shown therein and described below.

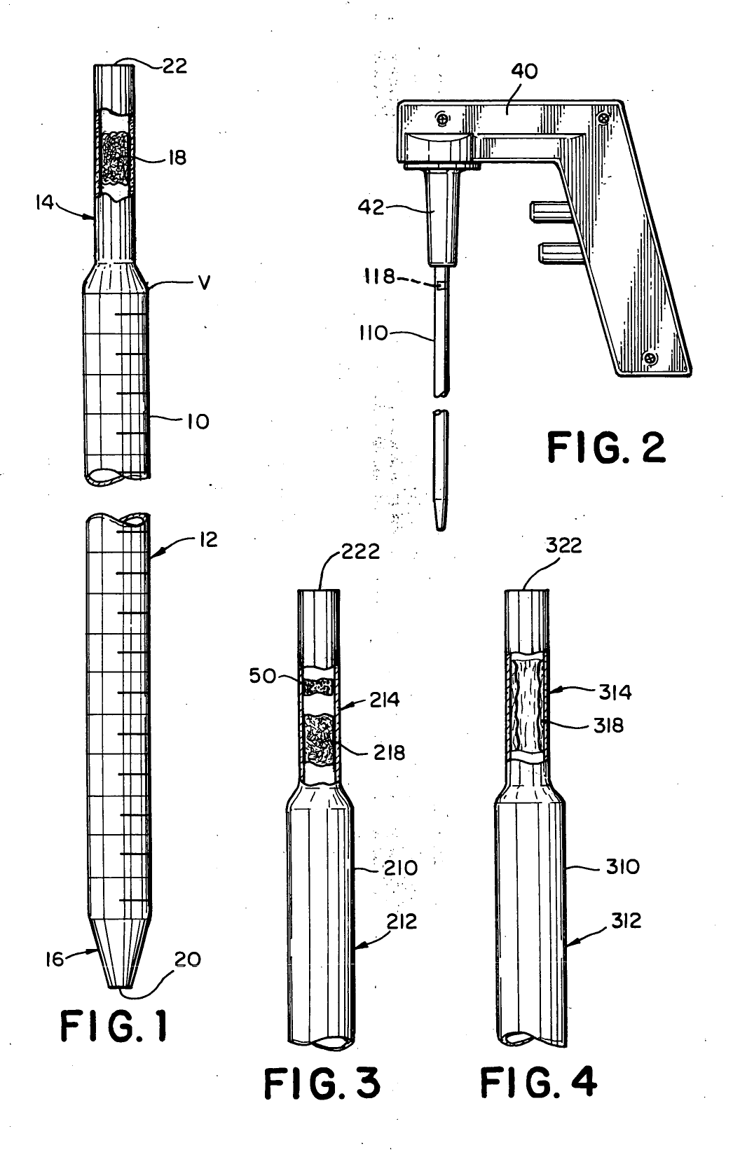

A pipette in accordance with a first embodiment of the present invention is shown in FIGS. 1 and 2 and is designated generally by reference numeral 10. The pipette 10 is constructed to releasably engage the nosepiece 42 of a hand-held pipette dispenser 40 such as the gun-type dispenser shown in FIG. 2.

Referring to FIG. 1, the pipette 10 is formed from a continuous piece of glass or plastic, and has a main body portion 12, an upper connection portion 14, and a lower tip portion 16. The lower tip portion 16 has an open end 20 and may be tapered. The upper connection portion also has an open end 22. The upper connection portion 14, main body portion 12, and lower tip portion 16 form a continuous liquid flow channel between the open ends 20, 22.

The pipette 10 has a predetermined maximum volume indicated by reference letter “V” on the main body portion. The diameter of the upper connection portion 14 is selected from standard sizes to cooperatively engage common pipette dispensers, such as the gun-type dispenser manufactured by Drummond Scientific Company and sold under the trademark PIPET-AID®. The diameter of the main body portion 12 may be different than the diameter of the connection portion 14, as shown in FIG. 1, or may be the same, as shown in FIG. 2, depending on the volume of the pipette.

In the embodiment shown in FIG. 1, an indicator 18 is located in the upper connection portion 14 of the pipette 10. The indicator 18 provides an observable indication that liquid has entered the connection portion 14 of the pipette 10, and thereby indicating that liquid may have also entered and contaminated the nosepiece 42 of the pipet gun 40. It is possible that liquid could contact and flow only slightly past the indicator without entering the nosepiece 42. In this situation, the indicator 18 would inaccurately predict that the nosepiece 42 has been contaminated. However, because the volume of the pipette 10 between the upper open end 22 and the indicator 18 is very small, this possibility is remote.

The location of the insert 18 within the connection portion is selected so that the insert 18 is visible by the technician when the pipette is connected to the nosepiece 42 of the pipette dispenser 40. For example, in the embodiment shown in FIG. 2, the insert is located at least about 1 in. from the open end 22 so that it is visually unobstructed by the nosepiece 42.

Preferably, the indicator 18 comprises an insert of material that changes its appearance after contacting liquid. For example, the indicator may change color or shape, or display an alpha or numeric message after contacting liquid. The insert may be a disc, plug, or any irregularly-shaped swab of material that can be easily inserted into the connection portion 14. The insert should be large enough that friction securely holds the insert in the connection portion 14 of the pipette 10. In the preferred embodiment, the observable indication from the indicator is irreversible to ensure that the technician is alerted to the contamination.

During metering, an aerosol may be generated from the liquid within the pipette. Depending on the volatility of the liquid, aerosol may be drawn into the connection end and through the indicator, thereby initiating a gradual change in appearance of the indicator. Further, depending on the chemical makeup of the indicator, ambient moisture may also initiate a change in the appearance of the indicator. Therefore, the indicator should preferably be treated with a deliquescing agent to prevent the indicator from changing color until contacted with liquid.

In the embodiment shown in FIG. 1, the insert 18 comprises a cotton swab that has been chemically treated with cobalt chloride and a deliquescing agent, such as salt. Cobalt chloride initially turns the cotton swab blue prior to contact with any aqueous solution. After the cotton swab contacts an aqueous solution, the cotton swab turns pink. Preferably, the deliquescing agent prevents the cotton swab from changing colors at high humidity levels such as at about 95% or below.

Other agents may be used to treat the insert 18 without departing from the scope of the invention. For example, the indicator 18 may comprise a cotton swab that has been treated with a chemical agent that does not initially discolor the cotton swab; however, upon contact with an aqueous or organic solution, the cotton swab becomes colored. Additional formulations using contamination indicators other than cobalt chloride may cause different color changes.

The insert 18 may be fabricated from man-made or organic materials, or a combination thereof. The insert preferably comprises a swab of single fibrous material or combination of fibrous materials that is packed into the pipette. Alternatively, the insert could be preformed into a shape that facilitates easy insertion into the pipette.

In a further embodiment of the invention, the insert may be custom designed to react with a predetermined agent present within the liquid being metered. The insert may be made of a material, infused with a material, or chemically treated with a material that reacts with the predetermined agent, thereby providing an observable indication that the predetermined agent is contained within the liquid. In this embodiment, the insert may provide a much more glaring indication when contacted by a liquid containing the predetermined agent. For example, if the pipette is intended to be used for metering liquids containing blood, the insert may be treated with luminol, which creates a vivid fluorescent reaction upon contact with blood. This embodiment also has particular application when contamination due to the intake of an aerosol is of particular concern since the color change of the insert after repeated exposure to the aerosol will be visible more quickly.

Preferably, the insert is located within the connection portion of the pipette and is only contacted if the pipette is overfilled. However, if it is desired to use the pipette as a disposable test device to detect the presence of the predetermined agent, the insert could be located within the central portion of the pipette so that the insert can be wetted without overfilling the pipette. Once the observable indication of the insert is triggered, the pipette is replaced with another.

In a yet another embodiment of the invention shown in FIG. 3, the pipette 210 has a construction similar to the pipette 10 shown in FIG. 1. The pipette 210 has a connection portion 214, main body portion 212, and lower tip portion (not shown). An indicator 218, similar in construction and function to the indicator 18 described above, is located in the upper connection portion 214.

The pipette 210 further includes a plug 50 intermediate the upper open end 222 and the indicator 218. The plug 50 acts as a barrier to passage of liquid into the nosepiece in the event the pipette 210 is overfilled with liquid. The plug 50 allows air to freely flow therethrough until the plug 50 contacts liquid. Once the plug 50 is wetted, it seals and becomes impervious to liquid or air flow. The plug 50 prevents liquid from entering the nosepiece of the pipette dispenser if the pipette is overfilled.

In the preferred embodiment, the plug 50 is made of a porous, hydrophobic sintered polyethylene material, which has been treated with a hydrophilic chemical. Upon contact with liquid, a reaction with the hydrophilic chemical closes the pores of the plug 50 and prevents further liquid from passing through the plug 50 and into the nosepiece of the pipetter. When the plug 50 seals and becomes impervious to air flow, liquid can no longer be admitted or expelled from the pipette 210, thereby forcing the operator to change pipettes.

Similar to the indicator 10 described above, the plug 50 can be treated with a chemical that reacts with a particular agent within the liquid. Additional plugs may also be added to the combination of the primary and secondary plug to affect a reaction that is indicated by a physical change or other visible or measurable change in properties of the combination of plugs.

In an additional embodiment shown in FIG. 4, the pipette 310 has a construction similar to the pipette 10 shown in FIG. 1. The pipette 310 has a connection portion 314, main body portion 312, and lower tip portion (not shown). An indicator 318 is located in the upper connection portion 314. The indicator 318 serves the same function as the indicator 18 described above but has a different construction. In this embodiment, the indicator comprises a chemical coating on at least a portion of the interior of the connection portion 314 of the pipette 310. The chemical coating has the same color-changing properties discussed above with respect to the insert 18. However, the chemical coating may be applied with an applicator or other means, rather than inserting and positioning the indicator 18.

A plurality of pipettes 10 can be provided and used to keep a record of the contamination history of the pipette dispenser. The record can be helpful to pinpoint the time or location of contamination if the contamination is not immediately noticed by the operator. For example, a protocol may be established whereby the pipette is changed after metering a predetermined quantity of liquid. After the predetermined quantity is metered, the pipette is replaced. Each used pipette is stored in an ordered series in a rack or other collection bin. The source of belatedly-discovered contamination could be traced back by reviewing the series of used pipettes and calculating the step in which the contamination occurred.

Alternatively, a plurality of pipettes could be used as a record to demonstrate that contamination did not occur if, for example, unexpected results are produced in an experiment. The used pipettes could be reexamined to confirm that none of the indicators had reacted.

While the principles of the invention have been described above in connection with specific embodiments, it is to be clearly understood that this description is made only by way of example and not as a limitation on the scope of the invention. For example, although the invention has been described and illustrated with respect to a serological pipette connected to a gun-type pipette dispenser, the scope of the invention encompasses other types of pipettes useful with other types of pipette dispensers.

1. A disposable, contamination-indicating pipette for metering liquids containing a specified agent, comprising:
a) a main body portion having a volume V and a diameter D;
b) an open-ended upper connection portion;
c) an open-ended lower tip portion; and,
d) an indicator in said connection portion that provides an observable indication that liquid has entered the connection portion.

2. The pipette recited in claim 1, wherein liquid can not flow out the open end of the connection portion without contacting said indicator.

3. The pipette recited in claim 1, wherein said observable indication is irreversible.

4. The pipette recited in claim 1, wherein said indicator comprises an insert of porous material that changes its appearance after contacting liquid.

5. The pipette recited in claim 1, wherein said indicator comprises a coating on the inner surface of said upper connection portion, said coating changing its appearance after contacting liquid.

6. The pipette recited in claim 4, wherein said insert comprises cotton that has been chemically treated to change color upon contact with a liquid.

7. The pipette recited in claim 7, wherein said cotton insert has been chemically treated with cobalt chloride.

8. The pipette recited in claim 1, wherein said indicator also provides an observable indication that the predetermined agent has entered the connection portion.

9. The pipette recited in claim 1, including a deliquescing agent that prevents said indicator from absorbing moisture unless the humidity level is greater than about 95%.

10. The pipette recited in claim 1, including means for preventing liquid from flowing out the open end of said connection portion.

11. The pipette recited in claim 10, wherein said preventing means comprises a material that is initially porous to air but becomes impervious to air and liquid upon contact with liquid.

12. The pipette recited in claim 4, wherein said porous material is initially porous to air but becomes impervious to air and liquid upon contact with liquid.

13. A disposable, contamination-indicating pipette for metering a liquid containing a specified agent, comprising:
a) a main body portion having a volume V and a diameter D;
b) an open-ended upper connection portion;
c) an open-ended lower tip portion; and,
d) an indicator in said connection portion that provides an observable indication that the particular agent has entered said connection portion.

14. The pipette recited in claim 13, wherein said indicator also provides an observable indication that the liquid has entered said connection portion.

15. A disposable, contamination-indicating pipette for metering liquids containing a specified agent, comprising:
a) a main body portion having a volume V and a diameter D;
b) an open-ended upper connection portion;
c) an open-ended lower tip portion;
d) an indicator in said connection portion that provides an observable indication that liquid has entered the connection portion; and,
e) an indicator in said connection end portion that provides an indication that the specified agent has entered the connection portion.

16. A method of metering liquid with a pipette dispenser and detecting whether the pipette dispenser has been contaminated, comprising the steps of:
a) providing a plurality of disposable, contamination-indicating pipette for metering liquids containing a specified agent, each pipette comprising:
i) a main body portion having a volume V and a diameter D;
ii) an open-ended upper connection portion;
iii) an open-ended lower tip portion; and,
iv) an indicator in said connection portion that provides an observable indication that liquid has entered the connection portion.
b) connecting one of said pipettes to a pipette dispenser;
c) metering liquid with said pipette;
d) observing the indicator each time liquid is admitted to the pipette;
e) replacing said pipette if an observable characteristic of the indicator changes.

17. A method of metering liquid with a pipette dispenser and recording the contamination history of the dispenser, comprising the steps of:
a) providing a plurality of disposable, contamination-indicating pipette for metering liquids containing a specified agent, each pipette comprising:
i) a main body portion having a volume V and a diameter D;
ii) an open-ended upper connection portion;
iii) an open-ended lower tip portion; and,
iv) an indicator in said connection portion that provides an observable indication that liquid has entered the connection portion.
b) connecting one of said pipettes to a pipette dispenser;
c) metering a predetermined quantity liquid with said pipette;
d) replacing said pipette after the predetermined quantity of liquid has been metered; and,
e) storing the used pipettes in an ordered series.
